(19) United States
(12) Patent Application Publication
(10) Pub. No.: US 2012/0311129 A1
(43) Pub. Date: Dec. 6, 2012

(54) IDENTIFYING A DIFFERENCE IN APPLICATIOIN PERFORMANCE

(76) Inventors: Rotem Steuer, Modin (IL); Michael Gopshtein, Yahud (IL); Eyal Kenigsberg, Dolev (IL)

(21) Appl. No.: 13/149,113

(22) Filed: May 31, 2011

(51) Int. Cl. G06F 15/173

(52) U.S. Cl. 709/224

(57) ABSTRACT

A method for identifying a difference in application performance includes identifying first recorded statistics pertaining to traffic of an application sniffed during a first period prior to an application change. Subsequent to the application change, causing a collection, at the node, of the application's traffic during a second period and recording second statistics pertaining to that traffic. An evaluation is generated from a comparison of the first statistics with the second statistics. The evaluation indicates a difference in application performance following the change.

### BACKGROUND

It is common for a web application to experience a performance issue. For example, response times to a client operation may be slow or simply desired to be improved. A web application can include web, application, and database servers. Addressing an application performance issue can include altering the application's deployment or architecture by, for example, altering the load balancing policy between servers or adding more servers. Identifying which particular change to implement may not be readily apparent.

### DRAWINGS

FIG. 1 depicts an environment in which various embodiments may be implemented.

FIG. 2 depicts a system according to an embodiment.

FIG. 3 is a block diagram depicting a memory and a processor according to an embodiment.

FIG. 4 is a block diagram depicting an implementation of the system of FIG. 2.

FIG. 5 is a flow diagram depicting steps taken to implement an embodiment.

### DETAILED DESCRIPTION

### Introduction

Various embodiments described below were developed in an effort to identify a difference in the performance of a web application. To solve an application performance issue, a change may be made to the deployment or architecture of the application. Often, however, one must speculate as to the particular change needed to improve performance. Moreover, any given change can increase costs associated with the application. Thus, it becomes important to discern if a given change, when implemented, achieved the desired results. In other words, it is important for a business operating a web application to know that while a cost was incurred, the change improved the application's performance. Or, if performance was not improved, ongoing costs associated with the change can be avoided.

Embodiments described in more detail below operate to passively quantify the consequences of an application change. To recognize a performance change, initial statistics pertaining to traffic of an application sniffed at a node are obtained. The initial statistics correspond to traffic at a time before the change to the application. Subsequent to the application change, the traffic is sniffed at the node and corresponding statistics are recorded. An evaluation is generated from a comparison of the statistics prior to the change and the statistics recorded subsequent to the change. That evaluation indicates a difference in application performance. For example, the statistics may be indicative of valid application responses. Where the rate of valid responses improves following the change, the evaluation indicates improved application performance. Where that rate does not improve, the evaluation can infer that the change had little or no effect and that the solution lies elsewhere. In the latter case, the change can be undone and the process repeats until an improvement is realized.

The following description is broken into sections. The first, labeled “Environment,” describes an exemplary environment in which various embodiments may be implemented. The second section, labeled “Components,” describes examples of various physical and logical components for implementing various embodiments. The third section, labeled as “Operation,” describes steps taken to implement various embodiments.

### Environment

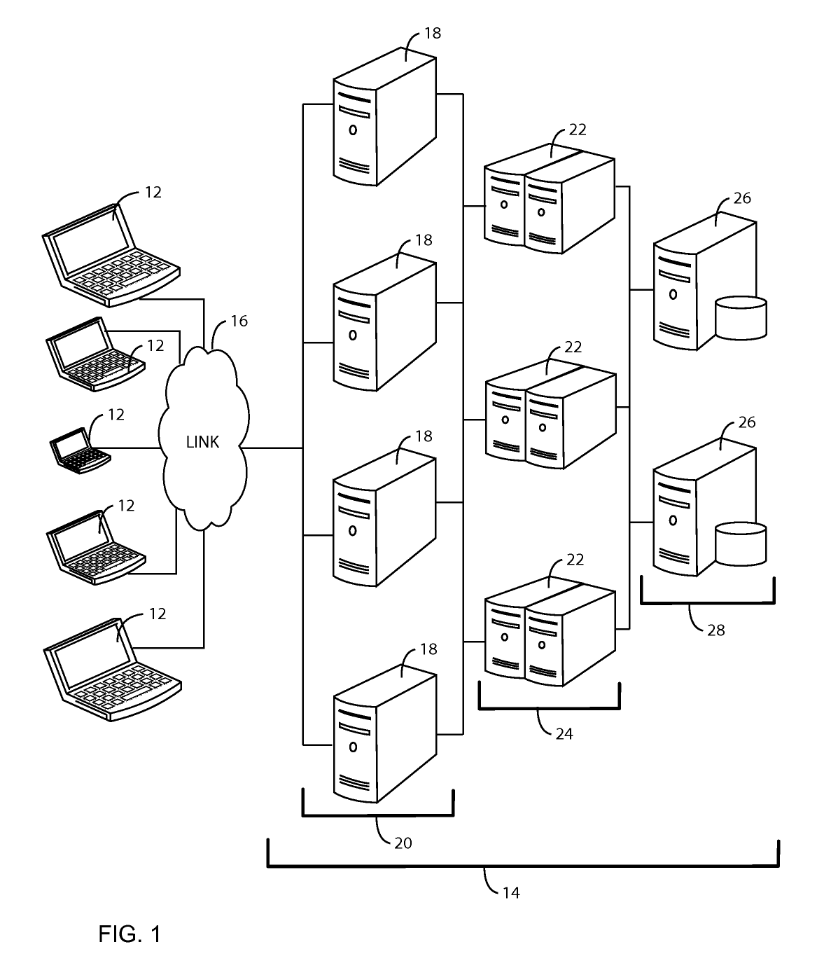

FIG. 1 depicts an environment 10 in which various embodiments may be implemented. Environment 10 is shown to include clients 12 and web application 14 connected via link 16. Clients 12 represent generally any computing devices capable interacting with a web application over a network such as the Internet. Web application 14, discussed in detail below, represents a collection of computing devices working together to serve an application over that network to clients 12. The application itself is not limited to any particular type.

Link 16 represents generally one or more of a cable, wireless, fiber optic, or remote connections via a telecommunication link, an infrared link, a radio frequency link, or any other connectors or systems that provide electronic communication. Link 16 may include, at least in part, an intranet, the Internet, or a combination of both. Link 16 may also include intermediate proxies, routers, switches, load balancers, and the like.

In the example of FIG. 1, application 14 is a web application that includes web servers 18 in a web server layer 20, application servers 22 in and application server layer 24, and database servers 26 in a database server layer 28. While each layer 20, 24, and 28 are depicted as including a given number of servers 18, 22, and 26, each layer 20, 24, and 28 can include any number of such servers 18, 22, and 26. Functions of application 14 are divided into categories including user interface, application logic, and application storage.

Web servers 18 represent generally any physical or virtual machines configured to perform the user interface functions of application 14 each functioning as an interface between clients 12 the application server layer 24. For example, where application 14 is an on-line banking application, web servers 18 are responsible for causing clients 12 to display content relevant to accessing and viewing bank account information. In doing so, web servers 18 receive requests from clients 12 and respond using data received from application layer 24. Servers 18 cause clients 12 to generate a display indicative of that data.

Application servers 22 represent generally any physical or virtual machines configured to perform the application logic functions of layer 24. Using the example of the on-line banking application, application servers 22 may be responsible for validating user identify, accessing account information, and processing that information as requested. Such processing may include amortization calculations, interest income calculations, pay off-quotes, and the like. In performing these functions servers 22 receive input from clients 12 via web server layer 20, access necessary data from application database layer 28, and return processed data to clients 12 via web server layer 20.

Database servers 26 represent generally any physical or virtual machines configured to perform the application storage functions of layer 28. Continuing with the on-line banking example, database servers 26 are responsible for accessing user account data corresponding to a request received from clients 12. In particular, web server layer 20 routes the request to application server layer 24. Application layer 24 processes the request and directs database layer 28 to return the data needed to respond to the client.

From time to time a web application such as application 14 experiences performance issues for which an improvement is desires. To address such issues, the application may be changed in some fashion. The change may include altering the deployment and architecture of the application 14 through the addition of a server in a given layer 20, 24, 28. Where the added server is a virtual machine, the addition is a relatively quick process. Additional web servers may be added with an expectation that client requests will be answered more quickly. The change may also include altering a policy such as a load balancing policy that affects the individual operation of a give server 18, 22, 26 as well as the interaction between two or more servers 18, 22, 26.

Identifying the particular change that will address a given performance issue can be difficult and not readily apparent. Finding the change can involve deep analysis and several of attempts before a performance improvement is realized for application 14. This can be especially true when dealing with virtual machines. For example, to relieve a perceived bottleneck in application 14, two servers 18 are added to web server layer 24 and no discernible response time is realized. This could mean that the bottleneck is not at the web server layer 20 but in application server layer 24 or database server layer 28. So, adding more web servers would not address the issue. On the other hand, the added web servers may cause application 14 to perform slightly better and the addition of more would reduce response time as desired. It is difficult to distinguish between those two cases. It can be even more difficult to measure the results of such changes when added servers are virtual machines.

It is important to note that applications such as the addition of servers costs money even when the servers take the form of virtual machines. There is a tangible benefit in understanding if a given change added value to application 14. In the scenario above, it is desirable to know if the two added web servers resulted in (1) no improvement or (2) perhaps a slight improvement which could indicate that the addition of more web servers would address the performance issue.

Solutions for quantifying the results of an application change are active and, as a consequence, interfere with the performance application 14 making it difficult to determine if the change it responsible for altered application performance. One active solution can include using agents installed on each server 18, 22, and 26 to measure consumption of memory and processor resources. Another active solution can include applying an artificial load on the application 14 and then measuring an average response time.

With an agent based approach, CPU and memory consumption measurements are used to determine if a change added value to application 14. Because, the agents the agents run of the servers they are measuring, their very existence affects those measurements leading to inaccurate results. For example, adding two application servers 22 may not change the average CPU or memory consumption at application server layer 24 where the inclusion of agents on the added servers caused them to maximize memory and CPU consumption. In a cloud environment or an environment with virtual servers, servers may be added automatically based on a current load balancing policy, that is, when memory or CPU consumption passes a threshold. It is not clear in such scenarios if the change added value to application 14. To summarize, an agent based approach may be flawed because it defects the application performance, provides inaccurate results, and, in some environments, can unnecessarily cause the addition of a virtual server adding unnecessary costs to application 14.

With a load testing approach, scripts generate an artificial load on application 14. The load includes a stream of server requests, for which the average response time is monitored to determine if a change added value to application 14. Like the agent based approach, a load test can artificially decrease application performance. During a load test on cloud environment having virtual servers, an artificial load may cause the automated addition of more virtual servers and incur additional unnecessary costs. Further, due to security concerns, it may not be possible or desirable to run a load test on some applications. For example, running a load test that accesses a bank customer's private records may violate security policies.

### Components

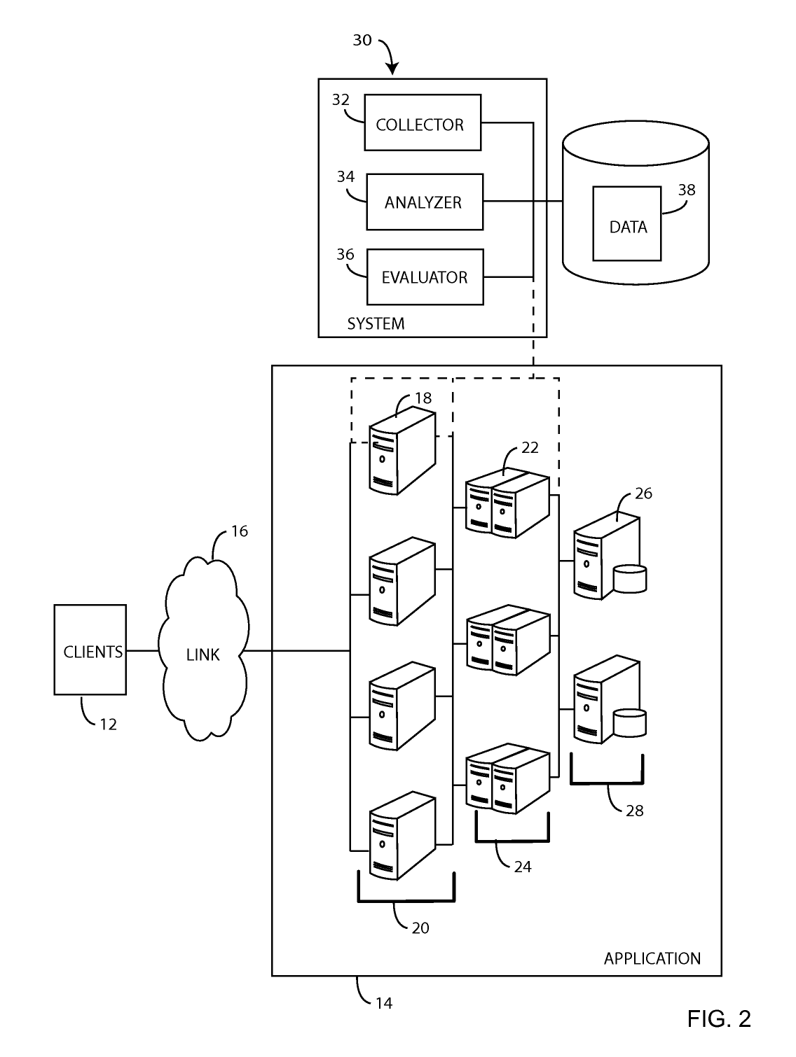

FIGS. 2-4 depict examples of physical and logical components for implementing various embodiments. FIG. 2 depicts system 30 for identifying a difference in application performance, that is, a difference in the performance of an application such as web application 14. In the example of FIG. 2, system 30 includes collector 32, analyzer 34, and evaluator 36. Collector 32 represents generally any combination of hardware and programming configured to sniff traffic of an application such as web application 14. In the context of application 14, the traffic includes communications between database server layer 28 and application server layer 24, communications between application server layer 24 and web server layer 20 and communications between web server layer 20 and clients 12. Thus, the traffic can be sniffed at nodes position between layers 20, 24, and 28 and between clients 12 and layer 20. The traffic may be traffic from an individual server 18, 22, or 26 or traffic from two or more such servers of a given layer 20, 24, or 28. Sniffing can involve logging electronic communication passing through those nodes by capturing data packets from streams of communications passing through those nodes.

Analyzer 34 represents generally any combination of hardware and programming configured to identify statistics pertaining to the traffic sniffed by collector 14. Analyzer 34 may do so by decoding sniffed data packets to show the value of various fields of the packets. Analyzer 34 can then examine the field values to discern statistics such as the rate of valid responses passing from a given layer 20, 24, or 28. Where for example, where the traffic is HTTP traffic, the valid responses would not include “HTTP 400 error” responses. For database traffic “DB error” responses would not be counted. Analyzer can then record those statistics as data 38 for later evaluation. Instead a valid response is a response to a request that includes the data requested.

Evaluator 36 represents generally any combination of hardware and programming configured to access data 38 and compare statistics recorded by analyzer 34. The compared statistics, for example, may include first statistics recorded prior to an application change and second statistics recorded subsequent to an application change. In comparing the statistics, evaluator 38 generates an evaluation indicating a difference in application performance caused by the change. For example, the first statistics may indicate a first valid response rate and the second statists a second valid response rate. Where the comparison reveals that the second rate exceeds the first, the evaluation may identify that difference as indicative of improved application performance resulting from the change. Evaluator, 36 may communicate the evaluation to a user for further analysis. Such a communication may be achieve by causing a display of a user interface depicting a representation of the evaluation or communicating a file representation of the evaluation so that it may be accessed by the user. As used here, a user may be a human user or an application.

In operation, collector 32 repeatedly sniffs application traffic over time, and analyzer 34 repeatedly identifies and records statistics concerning the sniffed traffic. Comparing statistics recorded before and after an application change, evaluator 36 generates an evaluation indicating a difference in application performance caused by the change. An application change may include a change in the operation of one of servers 18, 22, and 26. The application change may include a change in interaction between servers 18, 22, and 26 such as a change in a load balancing policy.

In performance of their respective functions, collector 32, analyzer 34, and evaluator 36 may operating in an automated fashion with collector 32 detecting the application change and, as a result, sniffing application traffic. Analyzer 34 responds by identifying and recording statistics pertaining to the sniffed traffic, and evaluator 38 responds by generating the evaluation. If the evaluation indicates that the change did not have positive results, evaluator 26 may recommend that that the change be reversed and the process repeated with a different application change. If the change had positive results, evaluator 38 may then recommend that the change be repeated to realize additional performance improvements or to stop if the desired results have been achieved.

As can be discerned from the discussion above, collector 32, analyzer 34, and evaluator 36 function passively with respect to application 14. That is, in performance of their respective functions they do not alter the performance of application 14. Collector 32 sniffs application traffic that has not been affected by an artificial load having been put on application 14. Processing resources of collector 32, analyzer 34, and evaluator 36 are distinct from the processing resources of servers 18, 22, and 26. Thus, collector 32, analyzer 34, and evaluator 36 do not consume memory or processing resources that may also be utilized by application 14.

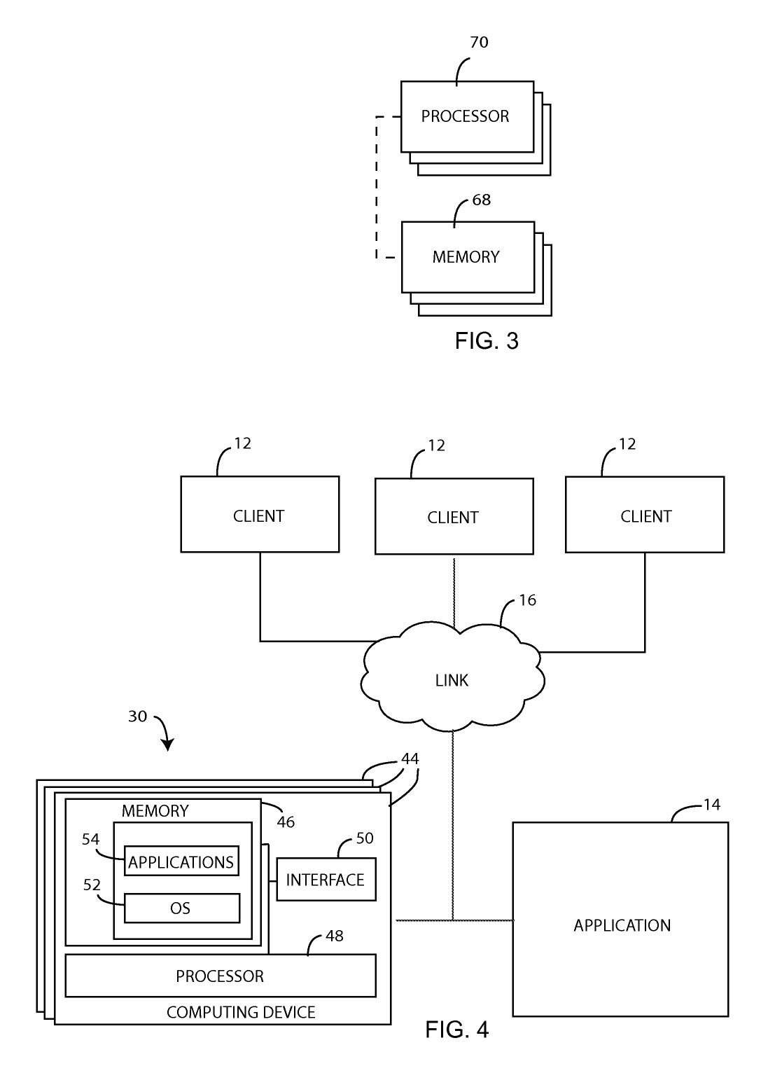

In foregoing discussion, various components were described as combinations of hardware and programming. Such components may be implemented in a number of fashions. Looking at FIG. 3, the programming may be processor executable instructions stored on tangible memory media 40 and the hardware may include a processor 42 for executing those instructions. Memory 40 can be said to store program instructions that when executed by processor 42 implement system 30 of FIG. 2. Memory 40 may be integrated in the same device as processor 42 or it may be separate but accessible to that device and processor 42.

In one example, the program instructions can be part of an installation package that can be executed by processor 42 to implement system 30. In this case, memory 40 may be a portable medium such as a CD, DVD, or flash drive or a memory maintained by a server from which the installation package can be downloaded and installed. In another example, the program instructions may be part of an application or applications already installed. Here, memory 40 can include integrated memory such as a hard drive.

As a further example, FIG. 4 depicts a block diagram of system 30 implemented by one or more computing devices 44. Each computing device 44 is shown to include memory 46, processor 48, and interface 50. Processor 48 represents generally any processor configured to execute program instructions stored in memory 46 to perform various specified functions. Interface 50 represents generally any wired or wireless interface enabling client device 44 to communicate with clients 12 and application 14. It is noted that the communication with application 14 may, but need not be, limited to the sniffing of application traffic.

Memory 46 is shown to include operating system 52 and applications 54. Operating system 52 represents a collection of programs that when executed by processor 48 serve as a platform on which applications 54 can run. Examples of operating systems include, but are not limited, to various versions of Microsoft's Windows® and Linux®. Applications 54 represent program instructions that when execute by processor 48 implement system 30, that is, for implementing a system for identifying differences in performance of application 14 as discussed above with respect to FIG. 2.

Looking at FIG. 2, collector 32, analyzer 34, and evaluator 36 are described a combinations of hardware and programming. The hardware portions may, depending on the embodiment, be implemented as processor 48. The programming portions, depending on the embodiment, can be implemented by operating system 52 and applications 54.

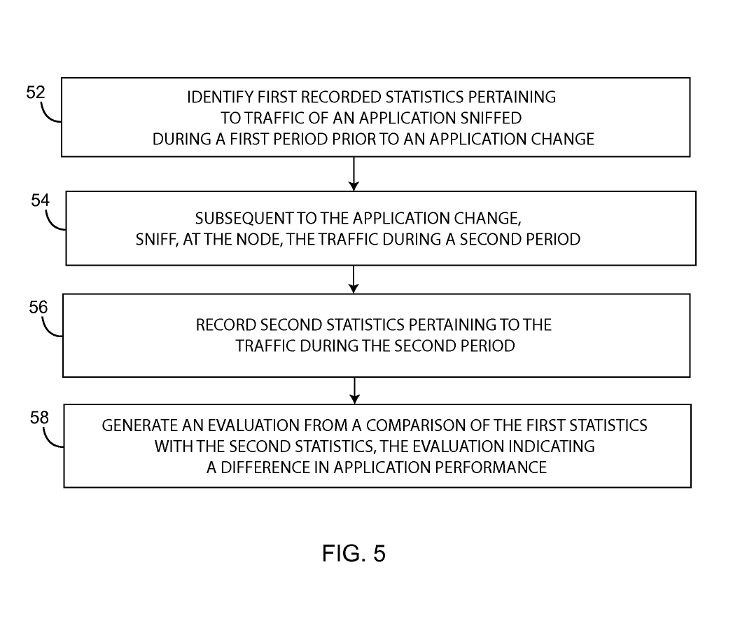

OPERATION: FIG. 7 is an exemplary flow diagram of steps taken to implement an embodiment in which differences in application performance resulting for an application change are identified. In discussing FIG. 5, reference may be made to the diagrams of FIGS. 1-4 to provide contextual examples. Implementation, however, is not limited to those examples. First recorded statistics are identified (step 52). The first statistics pertain to traffic of an application sniffed during a first period prior to an application change. Referring to FIG. 2, analyzer 34 may be responsible for step 52. In doing so, analyzer may acquire the statistics from data 38.

Subsequent to the application change, the application traffic is sniffed at the node during a second period (step 54). Second statistics pertaining to the application traffic during the second period are recorded (step 56). Referring to FIG. 2, collector 32 is responsible for step 54 while analyzer 34 is responsible for step 56. In performance if its tasks, analyzer 34 may record the second statistics in data 38.

The application may include one or more web servers, application servers and database servers. The node at which the traffic is sniffed may lie between two of the servers or between one of the servers and a client. The application change can include any of a change in number of the web, application and database servers, a change in an operation of one of the web, application and database servers, and a change in an interaction between two of the web, application and database servers.

An evaluation is generated from a comparison for the first statistics with the second statistics (step 58). The evaluation indicates a difference in application performance. Referring to FIG. 2, evaluator 36 may be responsible for step 58. In an example, first and second recorded statistics may include data indicative of a valid response rate. Here, the evaluation would indicate whether or not the valid response rate improved following the application change. That evaluation may then be caused to be communicated to a user for further analysis. Such a communication may be achieve by causing a display of a user interface depicting a representation of the evaluation or communicating a file representation of the evaluation so that it may be accessed by the user. As used here, a user may be a human user or an application.

Steps 52-58 may occur in an automated fashion. Step 54 may include detecting the application and as a result sniffing application traffic. If the evaluation generated in step 58 indicates that the change did not have positive results, the change may be reversed to avoid ongoing costs associated with that change. The process then repeats at step 54 after a different change is implemented. If evaluation indicates that the change had positive results, step 58 may also include recommending that the change be repeated to realize additional performance improvements with the process returning to step 54. If, however, the evaluation reveals that the desired results have been achieved, the process may end.

The steps 52-58 are performed passively with respect to the application that experienced the change. That is steps 52-58 are carried out without altering the performance of the application. The traffic sniffed in step 54 has not been affected by an artificial load having been put on the application 14. Further, processing and memory resources utilized to carry out steps 52-58 are distinct from the processing resources of the application. Thus, the performance of steps 52-58 do not consume memory or processing resources that may also be utilized by the application.

### Conclusion

FIGS. 1-4 aid in depicting the architecture, functionality, and operation of various embodiments. In particular, FIGS. 2-6 depict various physical and logical components. Various components illustrated in FIGS. 2 and 6 are defined at least in part as programs or programming. Each such component, portion thereof, or various combinations thereof may represent in whole or in part a module, segment, or portion of code that comprises one or more executable instructions to implement any specified logical function(s). Each component or various combinations thereof may represent a circuit or a number of interconnected circuits to implement the specified logical function(s).

Embodiments can be realized in any computer-readable media for use by or in connection with an instruction execution system such as a computer/processor based system or an ASIC (Application Specific Integrated Circuit) or other system that can fetch or obtain the logic from computer-readable media and execute the instructions contained therein. “Computer-readable media” can be any media that can contain, store, or maintain programs and data for use by or in connection with the instruction execution system. Computer readable media can comprise any one of many physical media such as, for example, electronic, magnetic, optical, electromagnetic, or semiconductor media. More specific examples of suitable computer-readable media include, but are not limited to, a portable magnetic computer diskette such as floppy diskettes or hard drives, a random access memory (RAM), a read-only memory (ROM), an erasable programmable read-only memory, or a portable compact disc.

Although the flow diagram of FIG. 5 shows a specific order of execution, the order of execution may differ from that which is depicted. For example, the order of execution of two or more blocks may be scrambled relative to the order shown. Also, two or more blocks shown in succession may be executed concurrently or with partial concurrence. All such variations are within the scope of the present invention.

The present invention has been shown and described with reference to the foregoing exemplary embodiments. It is to be understood, however, that other forms, details and embodiments may be made without departing from the spirit and scope of the invention that is defined in the following claims.

What is claimed is:

1. A processor implemented method, comprising:
identifying first recorded statistics pertaining to traffic of an application sniffed during a first period prior to an application change;
subsequent to the application change, sniffing, at the node, the traffic during a second period and recording second statistics pertaining to the traffic during the second period; and
generating an evaluation from a comparison of the first statistics with the second statistics, the evaluation indicating a difference in application performance.

2. The method of claim 1, wherein:
the first statistics include data identifying a valid response rate prior to the change and the second statistics include data identifying a valid response rate after the change; and
generating comprises generating an evaluation that indicates whether or not the change resulted in an increased valid response rate.

3. The method of claim 1m wherein the identifying, sniffing, and generating are performed without affecting the application.

4. The method of claim 3 wherein sniffing comprises sniffing traffic of the application that has not been affected by an artificial load placed on the application.

5. The method of claim 3, wherein sniffing comprises sniffing using a processor that does not affect the operation of the application.

6. The method of claim 1, wherein the application includes one or more web servers, application servers and database servers, the node is a node between two of the servers or between one of the servers and a client, and wherein the application change includes one of:
a change in number of the web, application and database servers;
a change in an operation of one of the web, application and database servers; and
a change in an interaction between two of the web, application and database servers.

7. The method of claim 1, comprising causing a communication of the evaluation to a user.

8. A system for identifying a difference in application performance, comprising an analyzer, a collector, and an evaluator, wherein:
the analyzer is configured to identify first recorded statistics pertaining to traffic of an application sniffed during a first period prior to an application change;
the collector is configured to, subsequent to the application change, sniff, at the node, the traffic of the application during a second period;
the analyzer is configured to identify and record second statistics pertaining to the traffic sniffed by the collector; and
the evaluator is configured to compare the first statistics with the second statistics and, based on the comparison, generate an evaluation indicating a difference in application performance caused by the change.

9. The system of claim 8, wherein the first statistics include data identifying a valid response rate prior to the change and the second statistics include data identifying a valid response rate after the change; and
The evaluator is configured to generate an evaluation that indicates whether or not the change resulted in an increased valid response rate.

10. The system of claim 8, wherein, in the performance of their respective tasks, the analyzer, the collector, and the evaluator do not alter application performance.

11. The system of claim 9, wherein the collector is configured to sniff traffic of the application that has not been affected by an artificial load placed on the application.

12. The system of claim 9, wherein the collector includes processing resources distinct from processing resources of the application.

13. The system of claim 8, wherein the application includes one or more web servers, application servers and database servers, the node is a node between two of the servers or between one of the servers and a client, and wherein the application change includes one of:
a change in number of the web, application and database servers;
a change in an operation of one of the web, application and database servers; and
a change in an interaction between two of the web, application and database servers.

14. A computer readable medium having processor executable instructions that when executed implement a method for identifying a difference in application performance, the method comprising:
identifying first recorded statistics pertaining to traffic of an application sniffed during a first period prior to an application change;
subsequent to the application change, causing a collection, at the node, of the application's traffic during a second period and recording second statistics pertaining to that traffic; and
generating an evaluation from a comparison of the first statistics with the second statistics, the evaluation indicating a difference in application performance following the change.

15. The medium of claim 14, wherein:
the first statistics include data indicative of a first valid response rate and the second statistics include data indicative of a second valid response rate; and
generating comprises generating an evaluation of a comparison of the first valid response rate with the second valid response rate, the evaluation indicating a difference in application performance measured by a difference between the first and second valid response rates.

16. The medium of claim 14, wherein the identifying, sniffing, and generating are performed without affecting the application.

17. The medium of claim 16, wherein sniffing comprises sniffing traffic of the application that has not been affected by an artificial load placed on the application.

18. The medium of claim 16, wherein sniffing comprises sniffing using a processor that does not affect the operation of the application.

19. The medium of claim 14, wherein the application includes one or more web servers, application servers and database servers, the node is a node between two of the servers or between one of the servers and a client, and wherein the application change includes one of:
a change in number of the web, application and database servers;
a change in an operation of one of the web, application and database servers; and
a change in an interaction between two of the web, application and database servers.

20. The medium of claim 14, wherein the method comprises causing a communication of the evaluation to a user.
